(19) United States
(12) Patent Application Publication
(10) Pub. No.: US 2009/0169892 A1
(43) Pub. Date: Jul. 2, 2009

(54) Coated Nanoparticles, in Particular Those of Core-Shell Structure

(76) Inventors: Rana Bazzi, Alfort Ville (FR); Olivier Renard, Fontanil-Cornillon (FR); Celine Noel, Grenoble (FR)

Correspondence Address: BRINKS, HOFER, GILSON & LIONE, P.O. BOX 1340, MORRISVILLE, NC, 27560, US

(21) Appl. No.: 12/293,486

(22) PCT Filed: Mar. 20, 2007
(86) PCT No.: PCT/EP2007/052654

§ 371 Date: Dec. 12, 2008

(30) Foreign Application Priority Data
Mar. 20, 2006 (FR) 0650950

(51) Int. Cl. B32B 5/16; B05D 7/00

(52) U.S. Cl. 428/404; 428/403; 427/215

(57) ABSTRACT

Bead comprising at least two non-agglomerated solid nanoparticles of core structure comprising only a solid core, or of core-shell structure comprising a solid core surrounded by a solid envelope or shell made up of an inorganic material, said nanoparticles being coated with a non-porous metal oxide.

Process for preparation of the said bead.

Material such as glass, a crystal, a ceramic or a polymer containing said beads.

### TECHNICAL FIELD

The invention relates to coated nanoparticles, said nanoparticles being in particular nanoparticles of core-shell structure.

The invention further relates to a process for the preparation of said coated nanoparticles.

The technical field of the invention can be very generally defined as that of nanoparticles and more precisely as that of the protection of these nanoparticles in order to preserve their properties when they are for example subjected to high temperatures for example up to 1500° C., to oxidation, to moisture, to chemical products, to ultraviolet light, and the like.

More particularly, the invention lies in the field of the protection of nanoparticles, in particular metallic ones, which have optical effects, such as intense pigmentation, or fluorescence, against heat treatments.

### PRIOR ART

The reduction in the size of a particle to the scale of a few tens of nanometres leads to marked changes in its physical properties and in particular in its optical response.

The latter has in particular been utilised since antiquity to create decorative glasses. The techniques for colouring ceramics and glasses were again developed with the alchemists of the Middle Ages (“aurum potabile”, “purple of Cassius”), but it was really only in the nineteenth century that Faraday [1] proposed the presence of aggregates of gold atoms as an explanation for the intense ruby-red coloration. Through the studies by Mie [2] at the start of the last century, an explanation was given for this intense coloration by metallic nanoparticles. Since these studies, there has been growing interest, both experimental and theoretical, in the study of metallic nanoparticles.

According to these studies, the colour of glasses containing metallic nanoparticles is attributed to the phenomenon of surface plasmon resonance. This term designates the collective oscillation of the conduction electrons of the particle in response to an electromagnetic wave. The electric field of the incident radiation causes the appearance of an electric dipole in the particle. To compensate for this effect, a force is created in the nanoparticle, at a unique resonance frequency. In the case of the noble metals, it lies in the visible range of the spectrum, in the blue around 400 nm, and in the green around 520 nm for small spheres of silver and gold respectively. It is responsible for the yellow and red colorations respectively of the materials obtained by dispersing these nano-objects in a transparent dielectric matrix. This oscillation frequency depends on several factors, including the size and the shape of the nanoparticle, the distance between the nanoparticles, and the nature of the surrounding medium.

The nanoparticles responsible for this aesthetic effect, known for a very long time and which is not on that account any less highly sought after in our times—particularly in the products of the glass industry, in decoration, and small bottle manufacture—are generally generated in situ by controlled heat treatments enabling germination and growth suitable for the final coloration sought.

Thus the preparation of nanoparticles of gold in a confined mineral medium can be effected in inorganic suspensions, for example of titanium, silica or clay, by reduction of a precursor of gold in the presence of a catalyst such as is in particular described by K. Nakamura et al [(2001) J. Chem. Eng. Jap. 34, 1538].

For other compounds and in particular those enabling the intense pigmentation of industrial glasses and coatings of the glaze or high temperature polymer type (fluorinated polymers), this approach is not used.

Industrially, the main problem encountered with these germination-growth processes is not the cost of the starting material, since by reason of their intensity of absorption the noble metals are only utilised in small quantity; in fact, the molar extinction coefficient is of the order of 10⁹ M⁻¹cm⁻¹ for gold nanoparticles of the order of 20 nanometres in diameter and increases almost linearly with the volume of the nanoparticles.

The major drawbacks connected with the use of the germination/growth process are rather those deriving:
from the inflexibility, rigidity, of the process, associated in particular with the control of the heat transfers and the lack of flexibility in the production plant;
and from the chemical vulnerability of the nanoparticles to the constituents of the matrix.

Thus the in situ germination process, even if it is currently that best mastered, appears unsuitable for the industrial development of this type of application, for example for the intense colouring of industrial glasses or of high temperature polymers such as the fluorinated polymers.

More generally, the incorporation of nanoparticles into a material (polymers, natural or synthetic fibres, glasses, ceramics, . . . ) or in a device based on a “bottom up” approach, with first of all synthesis of the nanoparticles, then incorporation into the interior of the matrix or the device, appears to be a more industrially suitable method.

There is a copious literature describing the synthesis of nanoparticles, and in the case in point considerable progress has been made in the last few years with regard to the synthesis of metallic nanoparticles, in particular gold nanoparticles, particularly as regards the stability and quantity of the nanoparticles, and the reliability of the process.

These processes can be broadly classified into two major categories: on the one hand the processes referred to as the “citrate route” and on the other the processes referred to as the “NaBH₄ route”.

Concerning the citrate route, of which there are many modifications (for example, that using a citrate and tannic acid), reference can for example be made to the document Natural Physical Science 241, 20-22,1973. In this process, the reduction of hydrogen tetrachloroaurate (HAuCI₄, 3H₂O) by citrate, for example Na citrate, in an aqueous phase leads to the rapid formation of a colloid wherein the gold nanoparticles are stabilised by the molecules of citrate adsorbed on the surface. The latter have a double role: they enable the control of the growth of the nanoparticles and prevent the formation of aggregates. A decrease in the size of the particles can be obtained through the concomitant utilisation of another reducing agent: tannic acid.

Concerning the NaBH₄ route, reference can in particular be made to the document J. Chem. Soc., Chem. Commun., 1655-1656, 1995. The NaBH₄ route consists essentially in the reduction of the hydrogen tetra-chloroaurate, in aqueous media, with sodium borohydride in the presence of a thiol. In this case, the surface of the gold particles is coated with a monolayer of the thiol molecules.

Efforts were then made to stabilise the nanoparticles or to confer on these nanoparticles particular chemical functions, in particular by providing them with a layer of chemically activatable functional silica.

Thus one of the currently most widely used processes [3] for the functionalisation and stabilisation of gold nanoparticles consists in first of all rendering their surface vitrophilic by addition of aminopropyltriethoxysilane (APTES) then using sodium silicate (Na₂O(SiO₂)₃₋₅, 27 wt. % SiO₂) for the growth of the layer of functional silica; in this way, stabilised particles of metal-silica core-shell structure are obtained.

In detail, in this document, first of all a dispersion of gold particles of mean diameter about 15 nm is obtained by reduction of HAuCl₄ with sodium citrate, to which an aqueous solution of (3-amino-propyl)trimethoxysilane (APS) or of tetraethoxysilane (TES) or else of 3-(trimethoxysilyl)propyl methacrylate (TPM) is added with stirring. The mixture of APS or the like and gold dispersion is left to stand so that total complexation of the amino groups with the surface of the gold takes place.

A solution of active silica is prepared by lowering the pH of a 0.54% solution of sodium silicate by weight to 10-11.

The solution of active silica is added with stirring to the dispersion of surface-modified gold particles, and the resulting solution is allowed to stand for 24 hours, so that the active silica polymerises on the surface of the gold particles.

Core-shell nanoparticles with a silica shell thickness of about 2 to 4 nm are thus obtained after 24 hours.

If it is desired to effect more substantial growth of the silica shell, recourse is had to a sol-gel process involving the hydrolysis of TES (tetra-ethoxysilane) or of another precursor of the silicon alcoholate type, catalysed by a hydroxide, such as ammonia, in an ethanol-water medium.

Silica shells of thickness from 10 nm to 83 nm and over are thus obtained.

However, the process of this document necessitates very prolonged operations if it is desired to grow thick shells. Furthermore, the coupling agent, such as APS and the sodium silicate can introduce impurities into the particles.

In order to eliminate the drawbacks of the process of document [3], the document [4] describes a process for the direct coating, with a silica shell, of gold nanoparticles stabilised with citrate, which does not require any coupling molecule. More precisely, gold nanoparticles, generally spherical, of diameter about 15 nm, are prepared by reduction of a gold salt, such as HAuCl₄.

The silica shell is grown by a sol-gel process of hydrolysis of a precursor, such as TEOS, in a water-ethanol medium catalysed by ammonia. The SiO₂ shell can reach 100 nm.

These processes are difficult to implement and their reproducibility is criticized.

In fact, most of the procedures proposed for the encapsulation of gold nanoparticles require two stages: namely, firstly the synthesis of the nanoparticles and then the encapsulation thereof. Certain processes even require three stages when a coupling agent is used [3].

However, an original route requiring only a single stage was proposed in the document [5], which makes it possible to effect the encapsulation in the course of the actual synthesis of the nanoparticles. This process is based on the utilisation of DMF which fulfils two different functions: in fact, it serves simultaneously to dissolve the gold salt and also to reduce it. The reaction proposed is as follows:

3HCONMe₂+2AuCl₄⁻+3H₂O→2Au⁰+3Me₂NCOOH+6H⁺+8Cl⁻

Since the synthesis of the gold particles takes place in anhydrous DMF, it is possible to utilise sol-gel chemistry reactions while controlling them to form the inorganic polymer which encapsulates them.

More precisely, in the document [5] a solution of titanium isopropoxide or zirconium propoxide and acetylacetone in 2-propanol is prepared.

A solution of AgNO₃ or of HAuCl₄₀.3H₂O in water and DMF is also prepared.

The two solutions are mixed and the colloid is precipitated by addition of toluene. The precipitate is washed several times with toluene and again dissolved in 2-propanol. This document indicates that it was possible to prepare core-shell nanoparticles of Au-TiO₂, Au-ZrO₂, Ag-TiO₂ and Ag-ZrO₂ with a crystalline core from 30 to 60 nm in diameter and an amorphous shell of 1 to 10 nm.

Nanoparticles, more particularly nanoparticles of metallic core/oxide shell structure, are obtained by the processes described above. Said shell, which is chemically inert, makes it possible to protect the core metallic nanoparticles and to make them stable under extreme chemical conditions.

However, the problem of the thermal and chemical stability of the nanoparticles, and in particular of the metallic nanoparticles, remains crucial during their incorporation into materials in order to confer novel properties onto the latter.

In particular, it is necessary to avoid process of degradation such as partial oxidation, undesired sintering between particles, sedimentation and inhomogeneities. The lack of stability of many colloidal preparations has in a way greatly slowed the development of applications.

This problem is further accentuated during the stages of dispersion and consolidation of the matrices receiving the nanoparticles, and the control of the size of the aggregates and the homogeneity is often inadequate. The final product is then of a quality and reproducibility unusable in the desired industrial applications.

The production and manipulation of ultrafine particles, for example metallic, with insertion into a material at relatively high temperature, for example from 500 to 1500° C., thus remains very problematic.

For example, the thickness of the shell, referred to as the priming shell or layer, surrounding the metallic core in the core-shell geometries formed in the processes of the prior art is such that this layer does not enable the complete thermal and/or chemical protection of the metallic nanoparticles (the core). When nanoparticles of core-shell structure are subjected to a heat flow, there is a risk of diffusion of the core across its shell, and sintering or undesired growth, resulting in a final dispersion prejudicial to the final properties of the nanoparticles and, in particular, to the desired final pigmentation.

The processes of the prior art thus do not make it possible to prepare particles protected against the environment, namely in particular thermally and/or chemically stable, homogeneous, and of controlled and managed size, size distribution and aggregation.

Furthermore, the nanoparticles prepared by the process of document [5] generally have a crystalline core of 30 to 60 nm and an oxide shell of about 3 nm thickness.

More precisely, these nanoparticles have sizes for example of 45±15 nm for particles of silver coated with ZrO₂ and about 50 nm on average for particles of gold coated with TiO₂.

These dimensions are still too large in particular for the optical effects preferentially desired in the present invention to be obtained.

In fact, in the process of document [5], the processes of core germination and growth are not sufficiently separated, and once a seed has formed this seed begins its process of maturation. Moreover, even if the synthetic route of document [5] enables the obtention in a single stage of nanoparticles with a gold core encapsulated by a fine layer of oxide (namely having a maximum 5 nm thickness), such as ZrO₂, it leads to the creation of particle systems which have no colloidal stability.

In view of the foregoing discussion, it is concluded that the nanoparticles of core-shell structure described and prepared in the documents of the prior art do not exhibit the chemical and thermal stability enabling them to resist very severe chemical environments and very high temperatures.

Moreover, the nanoparticles of these documents do not have the quality required, particularly as regards homogeneity, control of the size and control of the size distribution of the nanoparticles.

Finally, the core-shell nanoparticles of the prior art do not exhibit the dimensions, sizes, required for obtaining optical effects.

There thus exists a need for nanoparticles, in particular metallic nanoparticles, which display excellent chemical and heat stability, in any case superior to that of the nanoparticles of the prior art, as represented in particular by the documents cited above.

There is moreover a need for nanoparticles, in particular metallic nanoparticles whose homogeneity, quality, size, and size distribution are controlled. These nanoparticles must, in addition, exhibit a size appropriate for them to possess optical properties such as intense coloration.

There is further a need for a process which enables the preparation of such nanoparticles and which also does not display the drawbacks, limitations, defects and disadvantages of the processes of the prior art.

### DISCLOSURE OF THE INVENTION

The purpose of the present invention is to provide nanoparticles that inter alia meet these needs.

The purpose of the present invention is, further, to provide a process for the preparation of these nanoparticles.

The purpose of the present invention is also to provide nanoparticles which do not exhibit the drawbacks, defects, limitations and disadvantages of the processes of the prior art and which solve the problems of the processes of the prior art.

This purpose and still others are achieved, according to the invention, by a bead comprising at least two non-agglomerated solid nanoparticles of core structure comprising only a solid core, or of core-shell structure comprising a solid core surrounded by a solid envelope or shell made up, composed, constituted of an inorganic material, the said non-agglomerated nanoparticles being coated with a non-porous metal oxide.

According to the invention, bead is understood generally to mean an object, element having the shape of a sphere, or having essentially the shape of a sphere, having the form of a spheroid.

“Non-agglomerated”, solid nanoparticles is understood to mean that these nanoparticles do not form agglomerates, do not touch, are not in contact, are separated by the non-porous metal oxide, and can be individually displayed. In other words, there is a controlled spacing, distance, gap between the different nanoparticles.

Advantageously, the non-porous metal oxide is a refractory oxide.

Preferably, said nanoparticles are nanoparticles of core-shell structure comprising a solid core and a solid envelope or shell made up, composed, constituted of an inorganic material.

The non-porous metal oxide, preferably refractory, can be the same or different from the inorganic envelope, or shell, material.

Said nanoparticles can be simple nanoparticles, in other words nanoparticles not having the core-shell structure defined above and exhibiting, having, simply a core provided on its surface with chemical functional groups, chemical functionalities, ensuring their coating (i.e. the coating of the nanoparticles) by the preferably refractory non-porous metal oxide.

The said chemical functional groups can be selected from OH groups and organic ligands. They are preferably obtained during the nanoparticle synthesis stage.

The coating of nanoparticles, in particular particles of core/shell structure comprising a solid core and a solid envelope or shell, within a bead has never been described and suggested in the prior art.

Likewise, the coating of core or core-shell nanoparticles within a bead without these particles being agglomerated, adhered, and while these particles remain separate, distinct and individual has never been described nor suggested in the prior art.

According to the invention, it can be stated that the nanoparticles are incorporated within a protective matrix, in the form of a coating bead.

In addition, this coating bead makes it possible to ensure good dispersion and homogenisation within the final material into which the bead has to be incorporated.

The nanoparticles, brought into the form of “coating beads” according to the invention, meet the entirety of the needs enumerated above, and do not exhibit the defects of the nanoparticles of the prior art, which, fundamentally, are not coated in the form of a bead, and, finally, they bring a solution to the problems presented by the nanoparticles of the prior art.

Owing to the presence of the coating and on account of the actual nature of the material constituting it, and the low porosity thereof, protection, particularly chemical protection of the nanoparticles against their environment is ensured, which makes it possible to guarantee the totality of the properties of the nanoparticles under severe, for example, corrosive, oxidising or other chemical environments. The coating thus also makes it possible to render the nanoparticles “chemically invisible” with regard to an incorporation material and it is then possible to exceed the maximum incorporation thresholds beyond which the dispersion of the nanoparticles in the said material would become strongly heterogeneous, or indeed impossible: this is true in particular in the case of the ZrO₂ bead in glass.

It can be said that the characteristic of low porosity of the material constituting the coating is synonymous with the concept of dense coating. The idea is that in the case of porous materials, it will be possible for the atoms constituting the nanoparticles (core or core/shell) to diffuse through the coating and hence to migrate outside the nanoparticle. Likewise, a porous material will allow external agents to penetrate into contact with the nanoparticle and thus to destroy it by chemical reaction.

Moreover, the protection provided by the coating is also of a thermal nature. In fact, in an incorporation process necessitating heating of the nanoparticles to high temperatures, in particular beyond the melting point of the core material, non-protection of the nanoparticles would result in their destruction by an effect of solubilisation in the incorporation material, or an increase in their size due to an uncontrolled sintering effect, which would lead to the loss of the desired properties.

Thanks to their barrier properties making it possible to limit the diffusion and the growth of the nanoparticles, the coating of one or more, for example metal, nanoparticles, possibly in a tight, preferably refractory bead of oxide makes it possible, during heating beyond the melting point of the corresponding metal (in general, of the material constituting the core of the nanoparticles) to maintain a constant size of the nanoparticles and a controlled spacing, gap (for example at 100 nm) between the different particles, thus ensuring a constant optical effect of the coloration.

In other words, according to the invention, the chemical protection of the nanoparticles is effected, even beyond their melting point, and it then becomes possible to incorporate the nanoparticles into materials whose utilisation processes require heating to very high temperatures, such as vitreous materials.

Finally, the characteristics of the beads according to the invention can readily be modified by varying the parameters of the process.

Nanoparticles, and also beads of controlled sizes and a controlled size distribution, for example with a low dispersion, a “sharp” size distribution can thus be obtained, and aggregation of the particles can also be avoided.

Moreover, the nanoparticles, namely the core nanoparticle (said core itself alone constituting the nanoparticle or the core of a core-shell nanoparticle) and the core-shell nanoparticle are of smaller size, namely from 1 nm to 100 nm, compared to that of the nanoparticles described in the documents of the prior art, which renders them entirely suitable for the production of optical effects. In other words, the size of the core must not generally exceed 20 nm, preferably 10 nm, more preferably 5 nm and the overall size of the core and the shell must not generally exceed 100 nm.

Advantageously, the core of the nanoparticles of core structure or core-shell structure is in majority, mainly, made up, composed, constituted of at least one metal.

Advantageously, the average size of the said nanoparticles of core-shell structure is from 1 to 100 nm, preferably from 2 to 50 nm, more preferably from 5 to 20 nm, better from 5 to 10 nm.

Advantageously, the average size of the cores of the said nanoparticles of core structure or of core-shell structure is from 1 to 50 nm, preferably from 2 to 20 nm, more preferably from 5 to 15 nm, better from 2 to 10 nm.

The nanoparticles can have the form of spheres, lamellae, fibres, tubes, polyhedra, or a random shape. The sphere is the preferred shape.

Advantageously, the core of the nanoparticle or nanoparticles is made up, composed, constituted of at least 80% by weight of at least one metal, preferably of at least 90% by weight, and more preferably of 100% by weight of at least one metal.

The metal which mainly, in majority, constitutes the core of the nanoparticles can generally be selected from the elements of atomic number ranging from 13 to 82 and making up columns 3 to 16 of the periodic classification of the elements, and alloys thereof.

The core of the nanoparticles can be made up, composed, constituted of a mixture of two or more of the said metals and/or alloys thereof.

The core of the nanoparticles can be a composite core made up, composed, constituted of several zones, adjacent zones being made up of different metals, alloys or mixtures.

The said composite core of the nanoparticles can be a multilayer composite core comprising an internal core or nucleus made up, composed, constituted of a metal, alloy or mixture of metal, coated at least partially with a first layer of a metal, metal alloy or mixture of metals different from that making up, constituting the internal core or nucleus, and possibly with one or more other layers, each of these layers at least partially covering the previous layer and each of these layers being made up, composed, constituted of a metal, alloy or mixture different from the following layer and from the previous layer.

Generally, the core of the nanoparticles further contains inevitable impurities, and stabilisers.

The core of the nanoparticles can contain, apart from the main metal, metal oxides.

Advantageously, the metal which mainly, in majority, makes up, constitutes the core of the particles is selected from the transition metals, noble metals, rare earth metals, and alloys and mixtures thereof.

Preferably, the metal which mainly, in majority, makes up, constitutes the core of the nanoparticles is selected from aluminium, copper, silver, gold, indium, iron, platinum, nickel, molybdenum, titanium, tungsten, antimony, palladium, zinc, tin, europium and alloys and mixtures thereof.

More preferably, the metal which mainly, in majority, makes up, constitutes the core of the particles is selected from gold, copper, silver, palladium, platinum and alloys and mixtures thereof.

The metal preferred above all is gold.

The core of the nanoparticles can be surface-modified by a treatment modifying the physical and chemical properties thereof both in the case of “core” particles and in that of “core-shell” particles.

If the core is not in majority, mainly, made up, composed, constituted of a metal, it is mainly made up of a metal oxide, a sulphide, selenide or phosphide of a metal, for example of a transition or rare earth metal, or a semiconductor material.

Generally, the inorganic material which makes up, constitutes the envelope or shell of the nanoparticles in the case where this has a core-shell structure is selected from materials made up, composed, constituted of simple or compound metal oxides and/or organometallic polymers.

The said metal oxides can be selected from the oxides of silicon, titanium, aluminium, zirconium, yttrium, zinc, boron, lithium, magnesium, sodium, cerium, mixed oxides thereof and mixtures of these oxides and mixed oxides.

In particular, the metal oxide can be selected from silica, titanium oxide, alumina, zirconium oxide and yttrium oxide.

Generally, the envelope of each nanoparticle has an average thickness from 1 to 10 nm, preferably from 1 to 5 nm, more preferably from 1 to 2 nm and the core has a size from 1 to 50 nm, preferably from 2 to 20 nm, more preferably from 5 to 15 nm, better from 2 to 10 nm.

Advantageously, the inorganic material which makes up, constitutes the envelope of the particles in the form of a coating bead is selected from inorganic materials, such as metal oxides and organometallic polymers which can be obtained by a sol-gel process.

The, preferably refractory, non-porous, metal oxide is generally selected from the oxides of silicon, titanium, aluminium, zirconium, yttrium, zinc, . . . , mixed oxides thereof and mixtures of these oxides and mixed oxides.

Advantageously, the said oxide, preferably refractory, is selected from oxides which can be obtained by a sol-gel process.

Generally, the said preferably refractory, non-porous, metal oxide, has a thickness such that the diameter of the bead is from 50 to 3000 nm, preferably from 100 to 2000 nm, more preferably from 200 to 900 nm, better from 300 to 600 nm, and better still from 400 to 500 nm.

The bead can be made up, composed, constituted of from 2 to 10 nanoparticles coated with a preferably refractory, non-porous, metal oxide.

The invention also relates to a bead containing one or more solid nanoparticles of core structure comprising only a solid metal core, or of core-shell structure comprising a solid metal core surrounded by a solid envelope or shell made up, composed, constituted of an inorganic material, the said nanoparticle or nanoparticles being coated with a non-porous metal oxide, provided that when the bead only comprises one single nanoparticle of core structure, the non-porous metal oxide is not silica, and that when the bead comprises several nanoparticles these are not agglomerated.

This means that, in the case where the solid core is metallic, in other words made up, composed, constituted entirely and only of one or more metals, then the bead can contain only one single nanoparticle. All the other characteristics of the beads which have already been described above (for beads containing at least two nanoparticles) such as size, nature of the metal or metals, nature of the envelope and of the non-porous metal oxide, etc., can likewise apply to these particular beads which can contain only one single nanoparticle, which is then made up, composed, constituted of one or more metals. Reference is therefore expressly made to the entirety of the preceding description with regard to the characteristics of this type of bead wherein one single metal nanoparticle can be included.

The invention further relates to a bead of core-shell structure which comprises a core bead or beads as defined above, the said core bead containing one or more solid nanoparticles of core structure, or of core-shell structure, the said core bead being coated with a solid envelope or shell made up, composed, constituted of a non-porous metal oxide.

The said non-porous metal oxide forming the shell of the bead of core-shell structure is generally selected from the non-porous oxides already used above; and this oxide which forms, makes up, constitutes, the shell of the bead of core-shell structure is preferably different from the non-porous metal oxide which coats the nanoparticle(s) of the bead forming the core of the bead of core-shell structure.

Thus, if this non-porous metal oxide which surrounds the nanoparticles of the bead forming the core is silica, the non-porous metal oxide which forms the envelope or shell of the bead of core-shell structure can be selected from all the non-porous metal oxides with the exception of silica.

The thickness of the shell of generally refractory, non-porous metal oxide of the bead of core-shell structure is generally from 0.5 to 200 nm, preferably from 5 nm to 90 nm, more preferably from 10 nm to 30 nm.

This shell of the bead can thus for example have an average thickness of about 20 to 25 nm.

In the foregoing, nanoparticles of core-shell structure and beads of core-shell structure must not be confused. One nanoparticle or nanoparticles of core structure or of core-shell structure can be incorporated into a bead, a bead which can itself form the core of beads of core-shell structure.

The shell of the nanoparticles of core-shell structure can be referred to as a “shell” and the shell of the bead of core-shell structure, which can include one or more nanoparticles themselves possibly of core-shell structure (or of core structure) can be referred to as a “supplementary shell” or “second shell”.

The invention also relates to a process for the preparation of beads comprising one or more nanoparticles of core structure comprising a solid core, or of core-shell structure comprising a solid core and a solid envelope made up, constituted of an inorganic material, the said nanoparticles being coated with a preferably refractory, non-porous metal oxide, wherein the following successive stages, steps are performed:

a) solid nanoparticles making up, constituting the core of the said nanoparticles are prepared;

b) optionally, each of the said solid nanoparticles making up, constituting the core is surface functionalised or is surrounded by a solid envelope made up of an inorganic material, whereby, nanoparticles which are surface functionalised or of core-shell structure are obtained;

c) said nanoparticles are coated with a preferably refractory, non-porous metal oxide;

d) optionally, a further additional coating stage is performed with a preferably refractory, non-porous metal oxide.

It should be noted that this preparation process applies as well to beads with several nanoparticles as to beads containing only a single nanoparticle the core whereof is then metallic.

In addition, the optional stage, step d) is implemented in the case where it is desired to prepare beads of core-shell structure. Preferably, in stage, step d), the non-porous metal oxide utilised is different from the non-porous metal oxide of stage c).

Preferably, the process according to the invention is especially suitable for the synthesis of beads containing one or more nanoparticles of core-shell structure preferably having the average size indicated above and comprising a solid metallic core and a solid envelope made up, constituted of a metal oxide, the said nanoparticles of core-shell structure being coated with a preferably refractory, non-porous metal oxide, the same or different from the oxide of the envelope.

In this case, stages a) and b) are preferably combined, simultaneous, and nanoparticles of core-shell structure comprising a solid metallic core and a solid envelope made up, constituted of a metal oxide are prepared in a single stage, then during stage c) the said nanoparticles of core-shell structure are coated with a preferably refractory, porous oxide. Optionally, during stage d), the beads referred to as “core beads” obtained in stage c) are again coated with a preferably refractory, porous metal oxide, and “core-shell” beads are thus obtained.

Thus in this case the process for producing the beads comprises only two stages, namely stage a) combined with stage b), referred to as stage a₁), and stage c); and optionally another stage d).

In the process according to the invention, each nanoparticle is functionalised in stage b), optionally simultaneously with stage a), in other words preferably, in particular each of the nanoparticles referred to as “core”, for example metallic, is surrounded with an envelope, shell, or layer of solid primer made up, constituted of an inorganic material, such as a metal oxide. This layer of primer, particularly in the case of nanoparticles with metallic cores can be of a first metal oxide. This functionality makes it possible to confer adequate chemical reactivity on the core nanoparticles and serves as the starting point for incorporation (stage c) and optionally d)) in a second period, into the coating bead which itself confers the required thermal and chemical stability.

This coating bead also makes it possible to offer good dispersion and homogenisation within the final incorporation material.

The nanoparticles derived from the stages a) or b) can be very varied in nature, but overall they must generally exhibit on their surface the required chemical functional groups such as OH linkages for example in order to have chemical reactivity towards the coating process and to a sol-gel process; they must also be generally compatible with the latter in having colloidal stability in an alcoholic medium.

In order to be able to obtain such compatibility, in particular in the case of certain non-compatible nanoparticles having little chemical functionality/reactivity, the core-shell concept can be used, their core being the part really active optically for example and the shell whose surface exhibits the required functional groups (a few nanometres in thickness) making it possible to render the core compatible with the coating process.

On the other hand, in other cases where it would be possible to modify the chemical functional groups of nanoparticles, such as semiconducting nanocrystals, the process of compatibilisation would be quite different. For example, for semiconducting nanocrystals, this would consist in adsorbing onto their surface organic ligands making it possible to render them dispersible in alcohol.

And finally, in certain cases, it is not even necessary to effect any adaptation. For example, the nanoparticles of rare earths (see the example with Y₂O₃:Eu below) already possess, owing to the process of their synthesis (polyols route) the functional groups (OH) required for coating them in the refractory oxide. This is why in this case it is not necessary to functionalise them, nor to encapsulate them.

In the preferred two stage process, the first stage a₁) which makes it possible in a single step to prepare the core nanoparticles and to provide, equip them with the envelope, shell, or layer of primer can be effected by the process described in the document [5] cited above, namely by reduction of a salt of the metal making up, constituting the core, such as gold, with dimethylformamide (DMF), and simultaneous coating of the nanoparticles of metal thus formed by hydrolysis of a precursor of the metal oxide making up, constituting the envelope, such as an alcoholate of the metal of the oxide.

The metal salt can for example be selected from the nitrates, halides (chloride, bromide, iodide, fluoride), of the metals cited above for the core. In the case of gold, hydrogen tetrachloroaurate can be used.

A particularly preferred modification of the process, in only two stages, enables the obtention of stable colloidal solutions of metallic nanoparticles a few nanometres in diameter by utilising a powerful reducing agent such as NaBH₄ or Na citrate for example and/or by working in a dilute medium, as described in Example 2 below.

Such conditions favour the reduction of the metal salts of the metal forming the core and, consequently, the germination of the core metallic nanoparticles at the expense of their growth. The core nanoparticles thus prepared therefore have a size, for example a diameter, from 5 to 20 nm, preferably from 5 to 10 nm or 15 nm which is markedly lower than that of the core nanoparticles of the prior art.

In this particularly preferred modification of the process, the thickness of the shells is also limited, for example to 1 to 10 nm, by varying the conditions of synthesis of the shell simultaneous with the preparation of the metallic nanoparticles, by decreasing the quantity of the metal oxide precursor, for example of the metal alkoxide or alcoholate, such as zirconium alkoxide, and by observing a shorter heating time so that the growth takes place under thermokinetic control. The thickness of the shell is in fact regulated by the quantity of precursor for example of ZrO₂ brought into the medium.

The layer of primer, the shell or envelope prepared during stage b) whether or not simultaneous with stage a) or else during stage a1), does not make it possible to protect the nanoparticles chemically and/or thermally. However, this layer is essential for ensuring the stability of the nanoparticles in several solvents, in particular the alcohols, thus facilitating the implementation of stage c) (and then of the optional stage d)), which is the stage of formation of the coating bead of preferably refractory, non-porous oxide, which can be referred to as the protection stage.

This stage c) is preferably effected by a sol-gel process.

This sol-gel process generally comprises the hydrolysis of a precursor, for example of an alkoxide precursor, of the constituent metal of the preferably refractory, non-porous metal oxide.

Preferably, the controlled hydrolysis of the said precursors, for example of the said metal alkoxides, for example of zirconium alkoxide, is effected in an anhydrous alcoholic medium made up, constituted of one or more alcohols for example selected from butanol and isopropanol, in the presence of a long-chain, for example 10 to 20C, organic acid, such as oleic acid and in the presence of the nanoparticles of core-shell structure previously prepared during stages a) and b) or a₁).

The hydrolysis is thus controlled to the extent that the quantity of water present in the reaction medium is solely due to the addition of water which is introduced voluntarily.

It is generally preferable to operate under very anhydrous conditions, namely for example with anhydrous reagents, and a synthetic medium under a controlled atmosphere, otherwise the controlled growth reaction of the oxide beads is not observed.

In fact, the least trace of uncontrolled moisture can lead to the formation of a gel.

Stage d) is generally performed under the same conditions as stage a) but the preferably refractory, non-porous metal oxide deposited during this stage is preferably different from the non-porous metal oxide deposited during stage c).

Following stage c), or stage d) in the case where it is desired to prepare beads of core-shell structure, a heat treatment is performed, generally at a temperature from 100 to 800° C. and for a period from 1 to 24 hours.

This treatment makes it possible to free the beads formed of any organic residue and to densify the beads, for example of zircone.

A preferred heat treatment comprises the following stages:
increase from ambient temperature to the temperature of 450° C. at a heating rate of 5° C./minute;
maintenance at the level of 450° C. for a period of 3 hours;
increase from the temperature of 450° C. to the temperature of 650° C. at a heating rate of 5° C./minute;
maintenance at the level of 650° C. for a period of 5 hours;
return to ambient temperature at a cooling rate of 5° C./minute.

The characteristics of the beads formed vary depending on the concentration of water, the number of carbon atoms in the organic acid, the ageing time (this is the synthesis or maturation time), and the temperature (during the synthesis). Variation of these experimental parameters makes it possible to regulate, control the size of the beads, the size distribution of the beads and the aggregation of the nanoparticles.

The reference conditions ruling during stage c) (and optionally generally during stage d)) are given below in order to illustrate the influence of the different parameters of the process.

It will be noted that the conditions are not necessarily these preferred conditions and they are given simply by way of illustration:
molar concentration of the precursor, for example of the zirconium precursor: 0.1 M
molar concentration of the organic acid: 0.016 M
length of the carbon chain of the organic acid: C18 (in other words 18 carbon atoms in the carbon skeleton)
molar concentration of the total water present in the synthesis medium: 0.42 M
synthesis temperature: ambient temperature.

Influence of the water content (on the basis of the reference conditions):

| Molar | | Standard |
|---|---|---|
| concentration of | | deviation on the |
| water | Bead size | size distribution |
| 0.42 M | 1240 nm | 150 nm |
| 0.48 M | 840 nm | 170 nm |

Influence of the length of the carbon chain of the organic acid (on the basis of the reference conditions):

| Molar | | Standard |
|---|---|---|
| concentration of | | deviation on the |
| water | Bead size | size distribution |
| C10 | 1140 nm | 320 nm |
| C18 | 1240 nm | 150 nm |
| C20 | 2700 nm | 150 nm |

Influence of the synthesis temperature (on the basis of the reference conditions, with a C10 organic acid):

| Synthesis temperature | Bead size |
|---|---|
| −5° C. | 900 nm |
| 20° C. | 1140 nm |
| 50° C. | 2600 nm |

The concentration of nanoparticles makes it possible to regulate the proportion of nanoparticles per oxide bead.

The proportion of (core) nanoparticles is generally from 10 to 90% by weight, preferably from 50 to 80% by weight per bead.

The beads according to the invention can in particular be utilised as a colouring pigment resistant to high temperatures and/or chemical attack, in particular when the core is metallic.

Apart from the nature of the core, the coloration of the pigment will depend on the size of the metallic core, on the type and the thickness of the oxide layer utilised as possible envelope coating (this is the oxide forming the shell) and likewise on the level of incorporation of the beads in the material, matrix to be coloured or pigmented.

The beads according to the invention prepared by the process according to the invention can be incorporated into materials and matrices selected from silica glasses, metallic glasses, crystals, ceramics and high temperature polymers.

In particular, in glass matrices, the beads according to the invention make it possible to create visual, optical effects, by imparting to them in particular an intense coloration.

The in situ germination approach of the prior art makes it possible to incorporate 400 ppm of nanoparticles at the maximum into vitreous matrices. Beyond this threshold, the nanoparticles no longer have colloidal stability in the fused matrix, and precipitate.

Thanks to the beads according to the invention, it is possible in particular to attain an intense coloration by exceeding the solubility threshold and by being no longer limited by the optical extinction threshold; by incorporating the nanopigments developed according to the present invention during the matrix fusion stages.

The invention thus relates to materials such as glasses, ceramics and polymers, into which the beads according to the invention are incorporated, at a level generally from 100 to 5000 ppm, or even 10000 or 15000 ppm, preferably from 2000 to 4000 ppm, relative to the total weight of the material. This incorporation level is very high, markedly higher, for example in the case of glasses, than the levels of 400 ppm currently utilised.

The invention will now be described in detail in the description that is to follow, attached by reference to the appended drawings wherein:

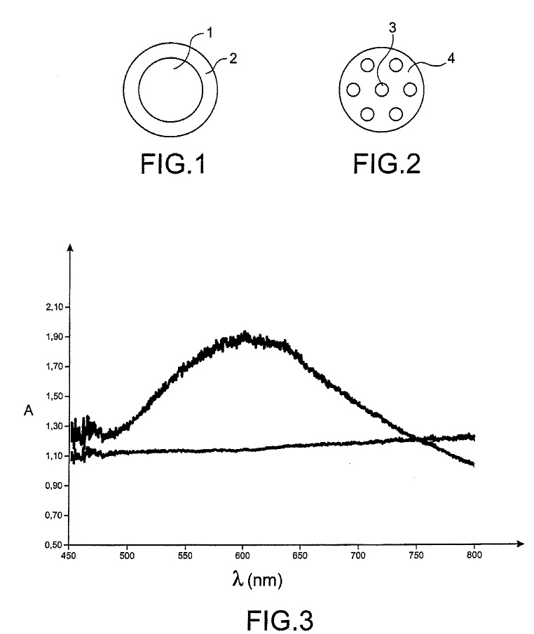

FIG. 1 represents a diagrammatic cross-sectional view of a nanoparticle of core, in particular metallic core, and shell, in particular oxide shell, structure intended to be coated in a bead according to the invention;

FIG. 2 represents a diagrammatic cross-sectional view of a bead according to the invention wherein several nanoparticles of core-shell structure as represented in FIG. 1 are incorporated into a refractory, non-porous oxide coating;

FIG. 3 is a graph which represents the absorption spectra of a glass into which are incorporated unprotected particles of gold (lower curve) and of a glass into which nanoparticles of gold protected by a bead of ZrO₂ are incorporated (upper curve). The absorbance A is plotted on the y axis and the wavelength λ (in nm) is plotted on the x axis;

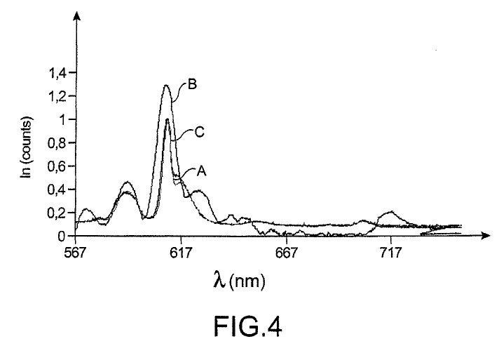

FIG. 4 is a graph representing the fluorescence spectra of nanoparticles of Y₂O₃:Eu protected or not protected by a ZrO₂ bead and having undergone a heat treatment at 1300° C. The intensity of fluorescence (In in “counts”) is plotted on the y axis and the wavelength λ (in nm) is plotted on the x axis.

Curve A is the fluorescence spectrum of nanoparticles of Y₂O₃:Eu not coated with ZrO₂ beads.

Curve B is the fluorescence spectrum of nanoparticles of Y₂O₃:Eu coated with ZrO₂ beads of a grain size of from 100 nm to 2000 nm.

Curve C is the fluorescence spectrum of nanoparticles of Y₂O₃:Eu coated with ZrO₂ beads of a grain size of about 10 nm.

FIG. 5 is a transmission electron microscopy (TEM) view, at a magnification of 80000, of a nanoparticle of gold core —SiO₂ shell structure prepared in Example 6.

The scale shown on FIG. 5 represents 100 nm.

FIG. 6 is a transmission electron microscopy (TEM) view, at a magnification of 80000, of a bead containing nanoparticles of gold core —SiO₂ shell structure coated with a layer of ZrO₂ prepared in Example 6.

The scale shown on the figure represents 100 nm.

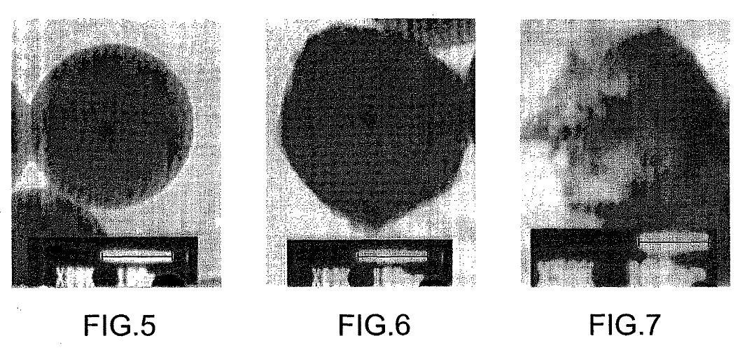

FIG. 7 is a transmission electron microscopy (TEM) view at a magnification of 80000 of a bead of zirconium oxide as produced in Example 6, incorporated into silica glass at a temperature of 1100° C. for 2 hours.

The scale shown on the figure represents 100 nm.

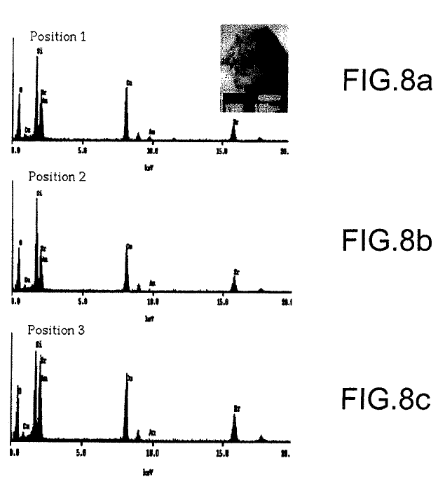

FIG. 8 represents the EDX spectra made on a zirconium oxide bead of Au-SiO₂-ZrO₂ structure as produced in Example 6 (FIG. 7), heat treated at 1100° C.

FIGS. 8a, 8b and 8c are respectively the EDX spectra made at points, positions 1, 2 and 3 of the bead represented in FIG. 7.

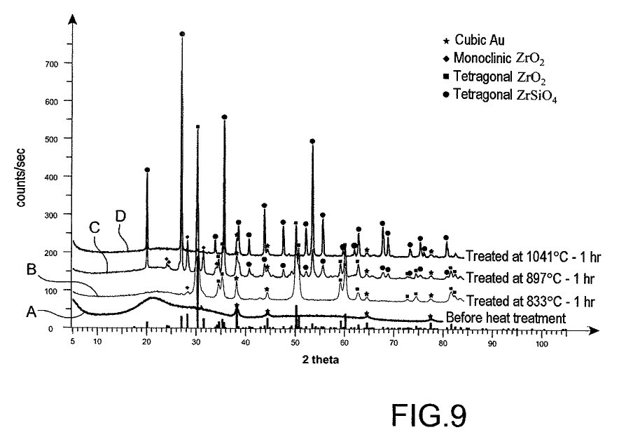

FIG. 9 represents the DRX spectra of beads of refractory mixed oxide ZrSiO₄ doped with copper ions (Au-ZrSiO₄: Cu) into which gold nanoparticles according to the invention are incorporated (Example 8).

The counts/sec are plotted on the y axis and 2 meta on the x axis.

The spectra are those of the beads before heat treatment (A), and after heat treatment respectively at 833° C. for 1 hour (B), at 897° C. for one hour (C) and at 1041° C. for 1 hour (D).

The * represent cubic Au, the ♦ represent monoclinic ZrO₂, the ▪ represent tetragonal ZrO₂, and the represent tetragonal ZrSiO₄.

In FIG. 1, a nanoparticle of core-shell structure intended to be coated in a bead according to the invention has been shown.

This bead comprises a core (1) which is made up, constituted of a solid material such as a metal or any other material described above. For example, the core is of gold.

When the core (1) is made up, constituted of a material with optical effects such as fluorescence, plasmon resonance, transmission or absorption effects, then it can be stated that this core constitutes the optically active part of the core-shell particle.

The core generally has an essentially spherical shape, as shown in FIG. 1, and a size defined by its diameter of from 5 to 15 nm.

The core is uniformly surrounded by a shell (2), also called a primer layer, functionalised and of thickness from 1 to 20 nm. This shell (2) can be of any one of the materials already described above, for example of ZrO₂ or SiO₂.

Preferably, the encapsulation is effected in ZrO₂ on account of its better refractory power and its high density.

FIG. 2 shows a bead of non-porous refractory oxide according to the invention. The said oxide (4) coats, surrounds, encloses several nanoparticles (3) such as those described above in FIG. 1. In FIG. 2, a bead enclosing seven nanoparticles (3) is represented, but it is quite obvious that this number of nanoparticles (3) has only been given by way of illustration and that from 1 to 10 nanoparticles (3) can be contained in each bead in the general case and from 1 to 10 nanoparticles in the case of metallic nanoparticles.

The bead shown in FIG. 1 can have a diameter from 50 to 2000 nanometres; preferably from 50 to 500 nm.

The invention will now be described with reference to the following examples, given by way of illustration and non-restrictively.

### EXAMPLE 1

In this example, metallic nanoparticles of gold equipped, provided, with a primer layer of ZrO₂, in other words nanoparticles of gold core —ZrO₂ shell structure which are intended to be incorporated into beads, are prepared according to the invention.

The procedure utilised to prepare these nanoparticles is inspired by that described in the document [5].

The procedure is carried out in a more diluted manner than in that document and a different composition of the reaction medium was used in order to obtain a smaller core size.

6.93 mg of gold salt (HAuCl₄, 3H₂O) are dissolved in 15 mL of DMF then transferred to a 100 mL flask.

5 mL of H₂O are added to the gold solution with stirring.

In a 250 mL flask, 8.205 μL of acetyl-acetone then 35.24 μL of Zr(OPr)₄ are added rapidly and with vigorous stirring to 40 mL of isopropanol. The DMF solution is next rapidly poured into the isopropanol one. The yellow, clear mixture is kept stirred for 10 mins then heated to reflux. After 10 minutes' heating, the initially yellow solution has become red-violet. This colour change indicates the reduction of Au³⁺ to Au₀ and the formation of gold nanoparticles. The colloidal solution thus obtained is stable: the nanoparticles do not precipitate.

The nanoparticles thus prepared have a gold core with an average size of 20 nm, each of the particles is individually coated with a shell of ZrO₂ with a thickness of 5 nm (FIG. 1). These particles are essentially spherical; for this reason, this size corresponds to their average diameter.

TEM photographs were made which clearly show a 22 nm gold nanoparticle encapsulated by a shell of ZrO₂ of thickness 3 nm.

### EXAMPLE 2

In this example, gold nanoparticles equipped, provided, with a ZrO₂ primer layer, in other words, nanoparticles of gold core —ZrO₂ shell structure which are intended to be incorporated into beads, are prepared according to the invention.

The procedure utilised to prepare the nanoparticles is slightly different from and complementary to the procedure employed in Example 1.

More precisely, in particular the dilution and the addition of a reducing agent are varied in order to maintain an average size of nanoparticles less than 20 nm instead of an average size of nanoparticles of about 20 nm in Example 1.

6.93 mg of gold salt (HAuCl₄, 3H₂O) are dissolved in 15 mL of DMF then transferred into a 100 mL flask.

2.5 mL of H₂O are added to the gold solution with stirring.

In a 250 mL round-bottomed flask, 8.205 μl of acetyl-acetone then 35.24 μl of Zr(OPr)₄ are added rapidly and with vigorous stirring to 40 ml of isopropanol. The DMF solution is next rapidly poured into the isopropanol one. The yellow, clear mixture is kept stirred for 10 mins then heated to reflux.

After several minutes' heating, the solution, initially yellow, becomes slightly pinkish.

At this stage, 2.5 ml of an aqueous solution containing 3.45 dg of sodium citrate are added to the solution and heating is maintained for 5 minutes and the solution becomes red. This colour change indicates the reduction of Au³⁺ to Au⁰ and the formation of gold nanoparticles.

The nanoparticles thus prepared have a gold core with an average size from 5 to 10 nm maximum. Each of the particles is individually coated with a ZrO₂ shell referred to as a “functionalisation shell” with a thickness of 5 nm. These particles are essentially spherical: for this reason their size corresponds to their average diameter.

### EXAMPLE 3

In this example, non-porous beads of zirconium oxide having an average size of 300 nm (size of bead) are prepared, these beads being essentially spherical, this size corresponding to their average diameter. The non-porous zirconium oxide encapsulates gold nanoparticles such as those prepared in Example 1 or indeed in Example 2.

The procedure is as follows:

0.06 mL of propionic acid are dissolved in 15.5 mL of butanol then transferred into a 100 mL round-bottomed flask (solution A).

In a 100 mL round-bottomed flask, 2.24 mL of Zr(OPr)₄ then 2 mL of a solution containing gold nanoparticles dispersed in isopropanol (produced as in Example 1 or else as in Example 2) are added rapidly and with vigorous stirring to 10 mL of butanol (solution B).

The solution B is next rapidly poured into the solution A. The mixture (solution C) is kept stirred for 30 minutes. Next a solution (D) containing 22 mL of butanol and 0.378 ml of H₂O is added to the solution C with stirring. After 20 minutes, the red, clear mixture becomes turbid. This change indicates the start of the formation of beads of zirconia. From this stage, the precipitation reaction is completed after 20 minutes. The reaction is then stopped by addition of 100 mL of butanol, and the stirring is stopped.

After a waiting time of 2 hrs, the solid is filtered off, washed three times with butanol, and once with anhydrous acetone and heated at 120° C. under vacuum for 3 hours.

The heat treatment which follows this stage can be summarised as follows:
Heating stage, step at 450° C. for 3 hrs, the passage from ambient temperature to 450° C. being effected at a heating rate of 5° C./min. This stage makes it possible to get rid of all the organic residue.
Heating stage at 650° C. for 5 hrs, the passage from 450° C. to 650° C. being effected at a heating rate of 5° C./min. This stage makes it possible to densify the zirconia beads.
Return to ambient temperature at a cooling rate of 5° C./min.

The product is then ready for use as a red colouring pigment resistant to high temperatures and chemical attacks.

### EXAMPLE 4

In this example, the beads of zirconium oxide produced in Example 3 containing a gold core are incorporated into silica glass at a temperature of 1100° C.

The glass obtained containing gold nanoparticles coated by beads of ZrO₂ is effectively a coloured glass: coloured zones correspond to gold nanoparticles which have been heat protected by the ZrO₂ bead.

Besides, a glass into which unprotected gold nanoparticles are incorporated during melting is prepared, and the absorption spectrum of these two types of sample is then studied (the wavelength λ in nanometres is plotted on the x axis, and the absorbance A on the y axis) (FIG. 3).

The first spectrum relates to the glass into which unprotected gold nanoparticles were incorporated during melting; the second relates to the glass into which gold nanoparticles protected by a ZrO₂ bead were incorporated during melting. The first spectrum (lower curve) shows that there is no specific absorption. On the other hand, the second spectrum (upper curve) shows an absorption peak corresponding to the presence of gold nanoparticles that have resisted the high temperature heat treatment (1100° C.).

### EXAMPLE 5

In this example, the incorporation of fluorophoric Y₂O₃:Eu nanoparticles, in other words of europium nanoparticles 3 nm in diameter equipped, provided, with a layer of Y₂O₃ primer, into a silica glass is effected. The Y₂O₃:Eu nanoparticles are incorporated into the glass in three different forms:

a) the Y₂O₃:Eu nanoparticles are incorporated into the melting glass without any protection, in other words the Y₂O₃:Eu nanoparticles are not coated according to the invention in a bead of ZrO₂;

b) the Y₂O₃:Eu nanoparticles incorporated into the glass are coated in beads of ZrO₂ a few hundreds of nanometres in diameter, namely from 100 nm to 2000 nm;

c) the Y₂O₃:Eu nanoparticles incorporated into the glass are coated in beads of ZrO₂ about 10 nm in size.

The fluorescence spectra of the Y₂O₃: Eu nanoparticles incorporated into the glasses in the forms a), b), c) above are then studied (FIG. 4).

In the fluorescence spectrum of a glass into which Y₂O₃:Eu nanoparticles are incorporated without protection (case a)): the main fluorescence peak (curve A) is fine, sharp which proves that the Eu is dispersed in the glass and is no longer in a nanometric structure.

On the other hand, when the nanoparticles are coated in a bead of ZrO₂ of a few hundreds of nano-metres (case b)), the width of the main fluorescence peak (curve B) is comparable to that obtained on a sample of nanoparticles in a colloidal medium. This enables us to confirm that the Eu has remained in a nanoparticulate structure and hence that the bead of refractory oxide ZrO₂ has fulfilled its role. On the other hand, if the size of the bead of ZrO₂ is too small (case c) (10 nm for example), then the protective function is not effective (curve C).

The conclusion from this example is that the study of the fluorescence signal from Y₂O₃:Eu fluorophores (FIG. 4) shows that they indeed remained in the nanoparticulate state thanks to beads of ZrO₂ wherein they are coated according to the invention.

### EXAMPLE 6

In this example, non-porous beads of zirconium oxide having an average size of 280 nm (size of bead) are prepared, these beads being essentially spherical, their size corresponding to their average diameter. The zirconium oxide encapsulates nanoparticles of gold core —SiO₂ shell structure. The procedure utilised to prepare these nanoparticles of core-shell structure is that described in document [4].

Thus, gold nanoparticles, generally spherical, of about 15 nm diameter, are prepared by reduction of a gold salt such as HAuCl₄. Then the silica shell is grown by a sol-gel process of hydrolysis of a precursor, such as TeOs, in a water-ethanol medium catalysed by ammonia. The shell of SiO₂ then reaches about 100 nm (FIG. 5).

These nanoparticles of gold core —SiO₂ shell structure are then centrifuged, then washed 3 times with anhydrous ethanol. They are then redispersed in 17 mL of anhydrous butanol in order to be encapsulated in non-porous zirconium oxide.

The procedure is as follows:

In a 100 mL round-bottomed flask, 2.24 mL of Zr(OPr)₄ are added rapidly and with vigorous stirring to 17 mL of butanol containing the nanoparticles of gold core —SiO₂ shell structure (solution A).

90.6 μL of acetylacetone are dissolved in 13.5 mL of anhydrous butanol then transferred into a 100 mL flask (solution B).

The solution B is next rapidly poured into the solution A. The mixture (solution C) is kept stirred for 30 minutes. Next, a solution D containing 22 mL of butanol and 378 μL of H₂O is added to the solution C with stirring. The stirring is stopped after 48 hrs. The beads are then recovered by centrifugation and washed 3 times with butanol and once with anhydrous acetone then dried at 120° C. under vacuum for 3 hrs.

The heat treatment which follows this stage can be summarised as follows:
Heating stage at 450° C. for 3 hrs, the passage from ambient temperature to 450° C. being effected at a heating rate of 5° C./min. This stage makes it possible to get rid of all the organic residue.
Heating stage at 750° C. for 5 hrs, the passage from 450° C. to 750° C. being effected at a heating rate of 5° C./min. This stage makes it possible to densify the zirconia bead.
Return to ambient temperature at a cooling rate of 5° C./min.

After this stage, the nanoparticles of gold core —SiO₂ shell structure are covered with a layer of ZrO₂ about 20 nm in thickness (FIG. 6).

The product is then ready for use as a coloration pigment resistant to high temperatures and chemical attacks.

### EXAMPLE 7

In this example, the beads of zirconium oxide containing a gold core produced in Example 6, are incorporated into silica glass at a temperature of 1100° C. for 2 hrs.

The glass obtained is coloured. The persistence of the colour can be directly linked to the presence of gold in the nanometric state. The gold nanoparticles thus coated therefore resisted the heat treatment at high temperature, that is to say beyond their melting point, and this for several hours. The same heat treatment was performed on particles outside the matrix in order to be able to analyse them by transmission electron microscopy. These analyses confirm the heat protection obtained thanks to the coating of the gold nanoparticles. In fact, it was possible to demonstrate the presence of the gold nanoparticles. The morphology of the bead overall is identical to that obtained before heat treatment and shown in FIG. 6. In fact, the gold nanoparticle of diameter about 15 nm is situated at the centre of a bead of 280 nm diameter (FIG. 7).

Chemical analyses confirmed the presence of the gold only at the centre of the particle whereas the shell is made up exclusively of zirconium oxide and silicon oxide (FIG. 8).

### EXAMPLE 8

In this example, metallic gold nanoparticles incorporated directly into beads of refractory mixed oxide ZrSiO₄ are prepared according to the invention. The procedure for preparing these particles is as follows:

In a 250 mL round-bottomed flask, 81.8 μL of acetylacetone then 355 μL of Zr(OPr)₄ are added rapidly and with vigorous stirring to 40 mL of isopropanol (solution A).

In a 25 mL beaker, 6.3 mg of gold salt (HAuCl₄, 3H₂O) are dissolved in 15 mL of DMF to which 5 mL of H₂O are then added with stirring (solution B).

The solution B is then poured rapidly onto the solution A. The yellow, clear mixture is kept stirred for 10 min then heated to reflux (solution C).

In a 25 mL beaker, 42.8 mg of copper acetate are dissolved in 5 mL of H₂O to which are added 1.4 mL of ammonia (solution D). The doping of the mixed oxide ZrO₂—SiO₂ with copper ions enables the formation of the zircon phase at lower temperature.

Once the colour of the solution C becomes red, the solution D is poured onto the solution C with vigorous stirring. Then 180 μL of TeOs are rapidly added. The mixture is then kept at reflux and under vigorous stirring for 30 min.

Finally, the particles are centrifuged and washed 3 times with ethanol before being dried under vacuum at 120° C. for 2 hrs. X-ray diffraction analyses made it possible to demonstrate the crystallisation of the zircon phase after heat treatment (FIG. 9). In fact, the shell, at first amorphous at ambient temperature, first of all crystallises into tetragonal ZrO₂, then the proportion of zircon increases until it becomes predominant after a heat treatment of one hour at 1041° C.

### REFERENCES

[1] M. FARADAY, Philos. Trans. R. Soc. (London) 147, 145 (1857).
[2] G. MIE, Am. Phys. (Leipzig) 25, 377 (1908).
[3] LIZ-MARZAN, L. M.; GIERSIG, M.; MULVANEY, P., Langmuir 1996, 18, 4329.
[4] MINE, E.; YAMADA, A.; KOBAYASHI, Y.; KONNO, M.; LIZ-MARZAN, L. M. J., Colloid Interface Sci. 2003, 385.
[5] TOM, R. T.; SREEKUMARAN Nair, A.; SINGH, N.; ASLAM, M.; NAGENDRA, C. L.; Reji Philip, R.; VIJAYAMOHANAN, K.; PRADEEP, T.; Langmuir 2003, 19, 3439.

1. Bead comprising at least two non-agglomerated solid nanoparticles of core structure comprising only a solid core, or of core-shell structure comprising a solid core surrounded by a solid envelope or shell made up of an inorganic material, said nanoparticles being coated with a non-porous metal oxide.

2. Bead according to claim 1, wherein the nanoparticles are nanoparticles of core structure provided on their surface with chemical functional groups, such as OH groups.

3. Bead according to claim 1, wherein the average size of said nanoparticles of core-shell structure is from 1 to 100 nm, preferably from 2 to 50 nm, more preferably from 5 to 20 nm, better from 5 to 10 nm.

4. Bead according to claim 1, wherein the average size of the cores of the said nanoparticles of core structure or core-shell structure is from 1 to 50 nm, preferably from 2 to 20 nm, more preferably from 5 to 15 nm, better from 2 to 10 nm.

5. Bead according to claim 1, wherein the average thickness of the envelope of said nanoparticles of core-shell structure is from 1 to 10 nm, preferably from 1 to 5 nm, more preferably from 1 to 2 nm.

6. Bead according to claim 1, wherein the nanoparticles have the form of spheres, lamellae, fibres, tubes, polyhedra, or a random shape.

7. Bead according to claim 1, wherein the core of the nanoparticles is, mainly, in majority made up of at least one metal.

8. Bead according to claim 7, wherein the core of the nanoparticle is made up of at least 80% by weight of at least one metal, preferably of at least 90% by weight, and more preferably of 100% by weight of at least one metal.

9. Bead according to claim 7, wherein the metal which mainly makes up the core of the nanoparticles is selected from aluminium and the elements of atomic number ranging from 13 to 82 and making up columns 3 to 16 of the periodic classification of the elements, and alloys thereof.

10. Bead according to claim 9, wherein the core of the nanoparticles is made up of a mixture of two or more of said metals and/or alloys thereof.

11. Bead according to claim 7, wherein the core of the nanoparticles is a composite core made up of several zones, adjacent zones being made up of different metals, alloys or mixtures.

12. Bead according to claim 11, wherein the composite core of the nanoparticles is a multilayer composite core comprising an internal core or nucleus made up of a metal, alloy or mixture of metal, at least partially covered with a first layer of a metal, metal alloy or mixture of metals different from that making up the internal core or nucleus, and optionally with one or more other layers, each of these layers at least partially covering the previous layer and each of these layers being made up of a metal, alloy or mixture different from the following layer and from the previous layer.

13. Bead according to claim 7, wherein the core of the nanoparticles further contains inevitable impurities, and stabilisers.

14. Bead according to claim 7, wherein the core of the nanoparticles further contains metal oxides.

15. Bead according to claim 7, wherein the metal which mainly, in majority, makes up the core of the nanoparticles is selected from the transition metals, noble metals, rare earth metals and alloys and mixtures thereof.

16. Bead according to claim 7, wherein the metal which mainly, in majority, makes up the core of the nanoparticles is selected from aluminium, copper, silver, gold, indium, iron, platinum, nickel, molybdenum, titanium, tungsten, antimony, palladium, zinc, tin, europium and alloys and mixtures thereof.

17. Bead according to claim 7, wherein the metal which mainly, in majority, makes up the core of the nanoparticles is selected from gold, copper, silver, palladium, platinum and alloys and mixtures thereof.

18. Bead according to claim 17, wherein the metal is gold.

19. Bead according to claim 1, wherein the core is surface-modified by a treatment modifying the physical and chemical properties thereof.

20. Bead according to claim 1, wherein the core of the nanoparticle is mainly made up of a metal oxide, a metal sulphide, selenide, or phosphide, for example of a transition metal or of rare earths, or a semi-conducting material.

21. Bead according to claim 1, wherein the inorganic material which makes up the envelope of the nanoparticles of core-shell structure is selected from materials made up of the simple or compound metal oxides and/or organo-metallic polymers.

22. Bead according to claim 21, wherein the metal oxides are selected from the oxides of silicon, titanium, aluminium, zirconium, yttrium, zinc, boron, lithium, magnesium, sodium, cerium, the mixed oxides thereof, and mixtures of these oxides and mixed oxides.

23. Bead according to claim 22, wherein the metal oxide is selected from silica, titanium oxide, alumina, zirconium oxide and yttrium oxide.

24. Bead according to claim 1, wherein the envelope of each nanoparticle of core-shell structure has a thickness from 1 to 10 nm, preferably from 1 to 5 nm, more preferably from 1 to 2 nm and the core has a size from 1 to 50 nm, preferably from 2 to 20 nm, more preferably from 5 to 15 nm, better from 2 to 10 nm.

25. Bead according to claim 1, wherein the inorganic material which makes up the envelope of the nanoparticles is selected from inorganic materials, such as metal oxides and organometallic polymers obtainable by a sol-gel process.

26. Bead according to claim 1, wherein said non-porous metal oxide is selected from the oxides of silicon, titanium, aluminium, zirconium, yttrium, and zinc, mixed oxides thereof and mixtures of these oxides and mixed oxides.

27. Bead according to claim 1, wherein the non-porous metal oxide is selected from the oxides obtainable by a sol-gel process.

28. Bead according to claim 1, wherein the non-porous metal oxide has a thickness such that the diameter of the bead is from 50 to 3000 nm, preferably from 100 to 2000 nm, more preferably from 200 to 900 nm, better from 300 to 600 nm, better still from 400 to 500 nm.

29. Bead according to claim 1 made up of from 2 to 10 nanoparticles coated with a non-porous metal oxide.

30. Bead according to claim 1, wherein the non-porous metal oxide is a refractory oxide.

31. Bead comprising one or more solid nanoparticles of core structure comprising only a solid metal core, or of core-shell structure comprising a solid metal core surrounded by a solid envelope or shell made up of an inorganic material, said nanoparticle or nanoparticles being coated with a non-porous metal oxide, provided that when the bead contains only a single nanoparticle of core structure the non-porous metal oxide is not silica, and that when the bead contains several nanoparticles these are not agglomerated.

32. Bead of core-shell structure containing a core bead according to claim 31, said core bead being surrounded with a solid envelope or shell made up of a non-porous metal oxide.

33. Bead of core-shell structure according to claim 32, wherein the non-porous metal oxide which makes up the shell of the bead of core-shell structure is different from the non-porous metal oxide which coats the nanoparticles of the bead forming the core of said bead of core-shell structure.

34. Process for the preparation of beads according to claim 1, comprising one or more nanoparticles of core structure comprising a solid core, or of core-shell structure, comprising a solid core and a solid envelope made up of an inorganic material, said nanoparticles being coated with a non-porous metal oxide, preferably refractory, wherein the following successive stages are performed:
a) solid nanoparticles making up the core of said nanoparticles are prepared;
b) optionally each of the said solid nanoparticles making up the core is surface functionalised or is surrounded by a solid envelope made up of an inorganic material, whereby nanoparticles which are surface functionalised or of core-shell structure are obtained;
c) said nanoparticles are coated with a preferably refractory, non-porous metal oxide;
d) optionally a further stage of additional coating is effected with a preferably refractory, non-porous metal oxide.

35. Process according to claim 34, wherein said nanoparticles have a solid metallic core, and the solid envelope is made up of a metal oxide.

36. Process according to claim 35, wherein the stages a) and b) are simultaneous and make up a stage a1).

37. Process according to claim 36, wherein the stage a1) is effected by reduction of a salt of the metal making up the core such as gold with dimethylformamide (DMF), and simultaneous coating of the nanoparticles of metal thus formed, by hydrolysis of a precursor, such as an alcoholate, of the metal oxide making up the envelope.

38. Process according to claim 35, wherein the nanoparticles of core-shell structure are prepared by reduction of a salt of the metal making up the core, with a powerful reducing agent such as NaBH4, or Na citrate and/or by operating in a dilute medium, and simultaneous coating of the nanoparticles of metal thus formed, by hydrolysis of a precursor, such as an alcoholate, of the metal oxide making up the envelope.

39. Process according to claim 34, wherein the stage c) and optionally the stage d) is effected by a sol-gel process, by hydrolysis of a precursor, such as an alkoxide precursor, of the preferably refractory, non-porous metal oxide.

40. Process according to claim 39, wherein the hydrolysis of said precursor, such as an alkoxide precursor, is effected in an anhydrous alcoholic medium made up of one or more alcohols, selected for example from butanol and isopropanol, in the presence of a long-chain, for example 10C to 20C, organic acid such as oleic acid, in the presence of the nanoparticles of core-shell structure previously prepared during the stages a) and b) or a1).

41. Process according to claim 34, wherein the non-porous metal oxide from the optional stage d) is different from the non-porous metal oxide from stage c).

42. Process according to claim 34, wherein, after stage c) or the optional stage d), a heat treatment is performed at a temperature of 100 to 800° C. and for a period of 1 to 24 hours.

43. Process according to claim 42, wherein the heat treatment comprises the following stages:
increase from ambient temperature to the temperature of 450° C. at a heating rate of 5° C./minute;
maintenance at the level of 450° C. for a period of 3 hours;
increase from the temperature of 450° C. to the temperature of 650° C. at a heating rate of 5° C./minute;
maintenance at the level of 650° C. for a period of 5 hours;
return to ambient temperature at a cooling rate of 5° C./minute.

44. Material wherein beads according to claim 1 are incorporated at a level from 100 to 5000, 10000 or 15000 ppm, preferably from 2000 to 4000 ppm relative to the total weight of the material.

45. Material according to claim 44, wherein the said material is selected from glasses, crystals, ceramics and polymers.

46. (canceled)
